(19) United States
(12) Patent Application Publication
(10) Pub. No.: US 2022/0245489 A1
(43) Pub. Date: Aug. 4, 2022

(54) AUTOMATIC INTENT GENERATION WITHIN A VIRTUAL AGENT PLATFORM

(71) Applicant: salesforce.com, inc., San Francisco, CA (US)

(72) Inventors: Juan RODRIGUEZ, Mountain View, CA (US); Michael MACHADO, Burlingame, CA (US)

(73) Assignee: salesforce.com, inc., San Francisco, CA (US)

(21) Appl. No.: 17/162,003

(22) Filed: Jan. 29, 2021

(51) Int. Cl. G06N 5/04; G06N 20/00; G06F 40/295; G06F 40/30; G06F 40/166

(52) U.S. Cl. CPC G06N 5/043; G06N 20/00; G06F 40/166; G06F 40/30; G06F 40/295

(57) ABSTRACT

The present disclosure is directed techniques for executing a task or service using a virtual agent. A method includes: defining a plurality of intents; conducting a first tier of machine learning analysis to compare a received input string with a first subset of training phrases associated with the plurality of intents to extract one or more parameters of the received input string; conducting a second tier of machine learning analysis to compare an output of the first tier of machine learning analysis with a second subset of training phrases associated with the plurality of intents, wherein the comparison is used to generate respective similarity scores indicating whether the received input string matches one or more of the second subset of training phrases; selecting an intent from among the plurality of intents based on the respective similarity scores; and executing an action associated with the selected intent.

### BACKGROUND

A virtual agent is an artificial intelligence (AI) element that provides customer services to a user. For example, a virtual agent may be a software agent that can perform tasks or services for the user based on verbal commands or questions. In some implementations, a user may ask the virtual agent questions, control home automation devices and media playback devices, and manage other tasks, e.g., manage emails, to-do lists, calendars, or the like. However, these tasks or services are pre-defined by an administrator of the virtual agent and are thus static in nature. Consequently, the user is beholden to the tasks or services that are pre-defined by the administrator.

### BRIEF DESCRIPTION OF THE DRAWINGS/FIGURES

The accompanying drawings are incorporated herein and form a part of the specification.

FIG. 1 is a block diagram of a system, according to some example embodiments.

FIG. 2 is a flowchart illustrating a process for executing, on a computing platform, an action based on a user command, according to some example embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

It is to be appreciated that the Detailed Description section, and not the Abstract sections, is intended to be used to interpret the claims. The Summary and Abstract sections may set forth one or more but not all example embodiments as contemplated by the inventor(s), and thus, are not intended to limit the appended claims in any way.

The present disclosure is directed to a virtual agent that may autonomously define custom intents. An intent may be a general description of a desired action, e.g., “create an event,” “log an event,” or the like. In some embodiments, the virtual agent of the present disclosure may analyze information from an application operating on a device or metadata associated with the user, i.e., privacy rights of the user, a role of the user, a history of actions previously taken by the user, or the like, and based on this information, the virtual agent may define the custom intents at run-time. In operation, the virtual agent may receive an input string associated with a user command from the user and determine a likely-performed-action from among the custom intents using a plurality of machine learning processes.

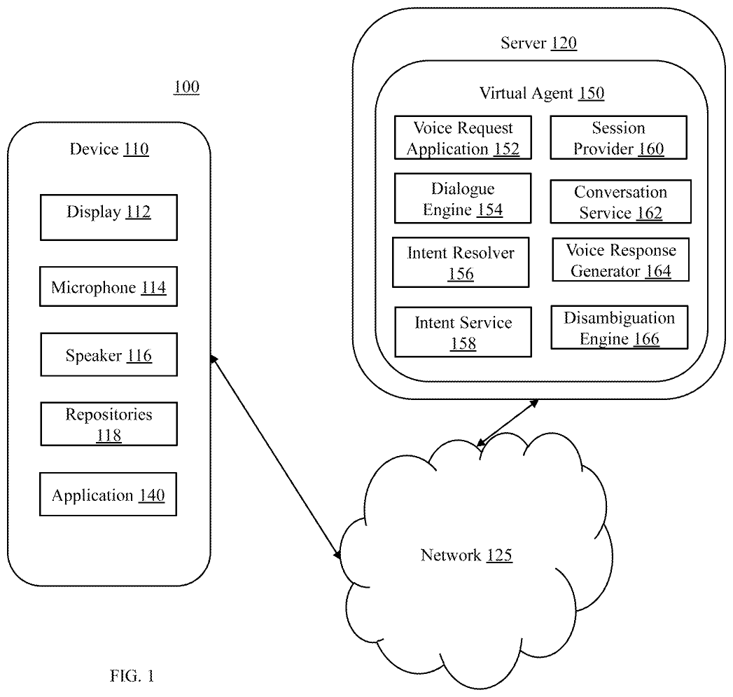

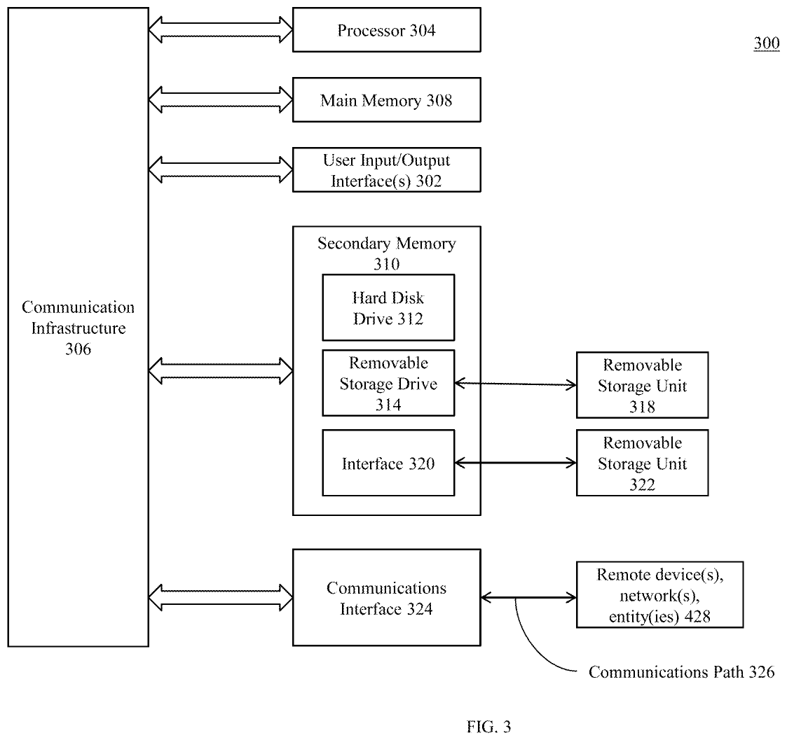

FIG. 1 is a diagram of an example environment 100 in which example systems and/or methods may be implemented. As shown in FIG. 1, environment 100 may include a device 110, a server 120, and a network 125. Devices of the environment 100 may interconnect via wired connections, wireless connections, or a combination of wired and wireless connections. Devices of environment 100 may include a computer system 300 shown in FIG. 3, discussed in greater detail below. The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

In some embodiments, the device 110 may be, for example, a mobile phone (e.g., a smart phone, a radiotelephone, etc.), a handheld computer, tablet, a laptop, a gaming device, a wearable communication device (e.g., a smart wristwatch, a pair of smart eyeglasses, etc.), or a similar type of device that is configured to operate an application, such as an application 140.

The network 125 may include one or more wired and/or wireless networks. For example, the network 125 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The server 120 may include a server device (e.g., a host server, a web server, an application server, etc.), a data center device, or a similar device, capable of communicating with the computing device 110 via the network 125.

In some embodiments, the device 110 may include a display 112, a microphone 114, a speaker 116, and one or more repositories 118. In some embodiments, the microphone 114 may be used to receive an audio input from a user. The audio input may be associated with the user command for one or more tasks or services, also referred to as an action. The one or more tasks or services may be, for example, a force function request. In some embodiments, the force function request may include a task oriented request, e.g., scheduling new events, creating a new contact, navigating to a particular location of a document, or the like. The audio input may be transmitted from the device 110 to the server 120 over the network 125

In some embodiments, in response to receiving the audio input form the device 110, the server 120 may process the audio input using a virtual agent 150 to execute the one or more tasks requested by the user. To achieve this, the virtual agent 150 may include a voice request application 152. The voice request application 152 may be configured to receive and process the audio input. In some embodiments, the voice request application 152 may operate independent of the virtual agent 150. For example, the voice request application 152 may operate on the same server 120 as the virtual agent, or the voice request application 152 may operate on a separate server and transmit the processed audio signal to the server 120 hosting the virtual agent 150. In some embodiments, the virtual agent 150, including the voice request application 152, may operate on the device 110.

The voice request application 152 may convert the user command into a received input string. For example, the voice request application 152 may convert the user command to the received input string using speech-to-text capabilities. In some embodiments, the voice request application 152 may include language translation capabilities, such that the user command may be translated into a different language as a text query. The text query may include the text-translation of the spoken word received from the user. For example, the user command may be “new appointment,” and the voice request application 152 may parse the user command input into the received input string, including “new appointment.” That is, the received input string may be a transcription of the user's spoken word.

The voice request application 152 may be executed by being activated in response to receiving an input from the user. For example, the voice request application 152 may be activated by receiving an audible command. In response to activating the voice request application 152, the user may provide the user command using the microphone 114, which may be transmitted to the voice request application 152. For example, the user may audibly state, “Please schedule my next appointment.” The microphone 114 may capture the user command, and in turn, the device 110 may transmit the user command to the server 120. Upon receipt, the voice request application 152 may convert the command into the received input string and transmit the received input string to a dialogue engine 154 of the virtual agent 150. In some embodiments, the dialogue engine 154 may be executed as an API that is called upon by the server 120. Alternatively, in some embodiments, the dialogue engine 154 may be executed as an API that is called upon by the application 140 operating on the device 110 or may be integrated within the application 140 as an API.

In some embodiments, the virtual agent 150 may process the received input string and execute an action based on the user command. To do so, in some embodiments, the virtual agent 150 may include a session provider 160, which is used to store a session when the user interacts with the virtual agent 150. The session provider 160 may determine whether a session on the virtual agent 150 exists. In the event that the session does not exist, the dialogue engine 154 may create a new session with one or more intents provided by an intent service 158 of the virtual agent 150. In other words, in some embodiments, the intent service 158 may define the one or more intents available for the new session at the time the session is created, i.e., the one or more intents may be dynamic intents defined at run-time. In the event that the session exists, the dialogue engine 154 may use the one or more intents present on the existing session. In some embodiments, the one or more intents may be modified by the intents themselves. Each session may include the intents, a session identification (ID), which may be set by the user, and context information, where values for intent parameters may be stored.

In some embodiments, the one or more intents available for the existing session or the new session may be based on information from the application 140 associated with the session or metadata associated with the user, i.e., privacy rights of the user, a role of the user, a history of actions previously taken by the user, or the like. Furthermore, in some embodiments, the session provider 160 may contain the one or more intents, as well as any context data used by the dialogue engine 154. In some embodiments, the intents may include, but are not limited to, read, create, or update. It should be understood by those of ordinary skill in the arts that these are merely examples of intents and that other intents are further contemplated in accordance with aspects of the present disclosure.

In some embodiments, the one or more intents may include a plurality of elements. For example, the plurality of elements may include an intent name, a plurality of parameters, one or more messages, an input context, and an output context.

The name may be, for example, a description of the intent. For example, the name may be “create event,” “update contact,” “log event,” “generic read,” or the like. It should be understood by those of ordinary skill in the art these are merely examples of names and that other names are further contemplated in accordance with aspects of the present disclosure.

The one or more parameters may include, but are not limited to, a parameter identification (ID), type, a name, a value associated with the name, a system definition, one or more required values, and/or a prompt. The parameter ID may be generated by the device 110 or the server 120.

In some embodiments, the one or more messages may be a response provided to the user. For example, the message may be a confirmation message that the action was completed, an acknowledgement, e.g., “thank you” or “okay,” or an indication that the action could not be completed.

The input context may be contextual information for executing an action associated with the user command provided by the user. For example, in order to create a new contact, the input context may be that the user should be logged into a personal account that grants access to an address book of the user. As another example, in order to create a new appointment, the input context may be that the user should be logged into a personal account that grants access to a calendar of the user. It should be understood by those of ordinary skill in the art that these are merely examples of input context and that other input contexts are contemplated in accordance with aspects of the present disclosure. In some embodiments, when the input context requires action by the user, e.g., logging into an account, the user may be prompted to perform such action.

The output context may be an output of executing the action associated with the intent. For example, the output context may be a new contact created in the user's address book or a new appointment scheduled on the user's calendar.

As one example, an intent may be “schedule a meeting on {{meeting_date}}.” In this example, the intent has one parameter with a parameter ID “meeting_date,” a type “DATE_TIME,” a required value of “true,” and a prompt “please enter the date for your meeting.” In this example, the user command may be “I want to schedule a meeting on Jan. 1, 2021,” with session ID “session_id_xyz.” Upon receiving the request, the dialogue engine 154 may determine that this is the first request with the session ID “session_id_xyz,” i.e., there is no session associated with the session ID “session_id_xyz.” In response, the dialogue engine 154 may create a new session containing the intent “schedule a meeting on {{meeting_date}}” provided by the intent service 158.

In some embodiments, the virtual agent 150 may also include a voice response generator 164. The voice response generator 164 may generate verbal responses for the user. For example, the voice response generator 164 may generate a verbal response that is transmitted to the device 110, which in turn may provide the user with audio via the speaker 116. The verbal response may include, for example, a welcome message to the user. For example, the welcome message may be “How can I help you today?” or the like. It should be understood by those of ordinary skill in the art that this is merely an example welcome message and that other welcome messages are further contemplated in accordance with aspects of the present disclosure. In some embodiments, other welcome messages may indicate which intents are available to the user or what are the most frequently used intents. In this way, the welcome message may be open-ended, i.e., a generic message, or close-ended, i.e., specifying specific intents to the user.

Based on the available intents, the dialogue engine 154 may process the received input string to determine which action to execute based on the one or more intents available for the session. For example, the dialogue engine 154 may determine an action to be taken by executing a plurality of machine learning analyses on the received input string.

In some embodiments, the dialogue engine 154 may conduct a first tier of machine learning analysis to compare a received input string with a first subset of training phrases associated with the plurality of intents to extract one or more parameters of the received input string. The training phrases may initially be generated by the intent service 158. And, in some embodiments, the training phrases may be generated by the one or more intents in order to have “follow-up” intents to refine interactions with the user. The first tier of machine learning analysis may include a named-entity recognition (NER) analysis. It should be understood by those of ordinary skill in the arts that this is merely an example of a first tier of machine learning analysis and that other types of machine learning analyses are further contemplated in accordance with aspects of the present disclosure.

In some embodiments, the dialogue engine 154 may parse the received input string to identify different parameters, e.g., words and/or phrases, of the received input string. Based on the different parameters of the received input string, the dialogue engine 154 may identify a first subset of a plurality of training phrases. For example, the received input string may be “schedule doctor's appointment tomorrow,” and the dialogue engine 154 may identify relevant sample training phrases, such as “log event {{event_date}}” and “new event {{event_date}}.” In this example, the term “event_date” may be a parameter that refers to an event date and has a type “DATE_TIME.” In some embodiments, the dialogue engine 154 may recognize that the terms “schedule,” “appointment,” and “tomorrow” are included in the received input string, which indicate that the received input string is related to an event and an event date. Using this information, the dialogue engine 154 may identify the first subset of the plurality of training phrases.

In some embodiments, the dialogue engine 154 may be unable to identify the first subset of the plurality of training phrases based on the received input string. For example, the received input string may include terms or phrases that do not match known training phrases, and in this case, the dialogue engine 154 may generate a request for more information, e.g., a prompt for a new user command, to clarify what has been requested, and the voice response generator 164 may convert the request into a verbal command provided to the user via the speaker 116. Additionally, the voice response generator 164 may provide an audible notification to the user that the user command was not recognized and, as such, a new user command is needed.

The dialogue engine 154 may use the first tier of machine learning analysis with both the received input string and the first subset of the plurality of training phrases, such that the first subset of the plurality of training phrases may be in the same or similar format as the received input string. That is, the first tier of machine learning analysis may be used to locate and classify named entities of the received input string and the first subset of the plurality of training phrases in unstructured text into pre-defined categories, such that the dialogue engine 154 may more efficiently compare them to one another. Using the example of “schedule doctor's appointment tomorrow,” the dialogue engine 154 may identify the named entities “schedule-event-date” in the received input string, and the named entities “log-event-and date” and “new-event-date,” respectively, in the first subset of the plurality of training phrases.

Using this information, the dialogue engine 154 may compare the named entities of the received input string and a first subset of training phrases associated with the one or more intents. Using the example of “log event tomorrow,” the dialogue engine 154 may recognize that the first subset of training phrases may include “Log event {{event_date}}” and “New event {{event_date}}.” Furthermore, by using the parameters for the first subset of the training phrases and the received input string, rather than specific values, the dialogue engine 154 may be executed using a reduced number of training phrases, thereby improving an efficiency of the server 120.

In some embodiments, based on determining the first subset of the training phrases, the dialogue engine 154 may conduct a second tier of machine learning analysis. The second tier of machine learning analysis may include, for example, a natural language expression analysis, a fuzzy logic analysis, or a natural language inference (NLI) analysis. In some embodiments, using the second tier of machine learning analysis, the dialogue engine 154 may replace each component of the received input string and the first subset of the training phrases with a corresponding entity type, compare the corresponding entity types of the received input string and a second subset of training phrases to determine a similarity score, and select an intent associated with a training phrase from among the second subset of training phrases having a highest similarity score that exceeds a threshold.

Continuing with the example of “Log event tomorrow,” the training phrases of “Log event {{event_date}}” and “New event {{event_date}}” each have one parameter type of DATE_TIME. Therefore, the second tier of machine learning analysis may be used to analyze the received input string to recognize the parameter type DATE_TIME. In this example, the second tier of machine learning analysis may recognize the term “tomorrow” as the parameter type DATE_TIME. In response, the second tier of machine learning analysis may substitute the term “tomorrow” in the received input string and compare the received input string having the substituted parameter type to a second subset of training phrases. In some embodiments, this may be performed using the NLI analysis.

In some embodiments, for each training phrase of the second subset of training phrases, the second tier of machine learning analysis may calculate a similarity score based the comparison. The similarity score may be calculated using, for example, a logistic regression algorithm. The similarity score may be based on a scale from 0 to 1. It should be understood by those of ordinary skill in the arts that this is merely an example for calculating the similarity score and that other algorithms for calculating the similarity score are further contemplated in accordance with aspects of the present disclosure.

In some embodiments, the second subset of training phrases may be larger than the first subset training phrases. The second subset of training phrases may be more refined examples of the identified intent type. For example, for the received input string of “schedule doctor's appointment tomorrow,” the second subset of training phrases may include common parlance phrases used to schedule an event. For this example received input string, some examples of the second subset of training phrases may include “I would like to schedule an appointment” or “Please schedule my next doctor's appointment for {{date}}.”

In some embodiments, the dialogue engine 154 may analyze which actions are requested by the user to rank the actions from most frequently used to least frequently used, or vice-versa. The dialogue engine 154 may use this ranking to determine the similarity score.

In some embodiments, the dialogue engine 154 may compare the similarity score to a threshold level, e.g., a similarity score of 0.8. The dialogue engine 154 may determine that the received input string matches one or more of the second subset of training phrases when the similarity score exceeds the threshold. It should be understood by those of ordinary skill in the art that this is merely an example threshold level, and that other threshold levels are further contemplated in accordance with aspects of the present disclosure.

In some embodiments, the dialogue engine 154 may identify an intent based on which training phrase from the second subset of training phrases has the highest similarity score, and execute one or more tasks associated with the determined intent.

In some embodiments, the dialogue engine 154 may determine that the received input string is incomplete. For example, the received input string may be incomplete, and in response, the dialogue engine 154 may determine that additional information is needed from the user. For example, the user command may be “schedule appointment,” and the dialogue engine 154 may determine that the user command is missing, for example, a date associated with the appointment. In response, using the voice response generator 164, the virtual agent 150 may prompt the user to provide this information.

In some embodiments, the dialogue engine 154 may also determine that the input context is not satisfied. For example, the dialogue engine 154 may determine that the user is not logged into their account that provides access to, for example, a calendar or an address book of the user, such that the dialogue engine 154 cannot update/add different appointments or contact information, respectively. In response, using the voice response generator 164, the virtual agent 150 may prompt the user to satisfy the input context to enable to the dialogue engine 154 to execute the action.

In some embodiments, in response to identifying the highest-matching intent, the dialogue engine 154 may use the processes described herein to identify one or more nested intents. For example, the nested intents may be one or more sub-tasks/sub-services that are dependent on the highest-matching intent. The nested intents may be defined using the intent service 158 and the session provider 160 based on a context of the highest-matching intent.

The virtual agent 150 may also include an intent resolver 156 that is configured to execute the action associated with the user command. For example, the intent resolver 156 may transmit data to or receive data from another source in order to complete the action, e.g., transmit data to or receive data from the user's calendar or address book.

In some embodiments, the virtual agent 150 may also include a context disambiguation engine 166, as discussed in co-pending U.S. patent application No. XXX, titled “Context Disambiguation Within A Virtual Agent Platform,” filed on XXX, the contents of which are hereby incorporated by reference.

In some embodiments, using the voice response generator 164, the virtual agent 150 may provide a notification to the user. For example, based on the messages of the intent matching the received input string, the virtual agent 150 may provide an audible notification confirming that the action has been completed, that the action could not be completed as requested, that an error occurred while trying to execute the action, or an acknowledgement, such as “thank you” or “okay.” The notification may be provided to the user via, for example, the speaker 116.

In some embodiments, using a conversation service 162, the virtual agent 150 may store a conversation between the user and the virtual agent 150. In some embodiments, the conversation may be stored to identify new intents that may be added to the one or more intents. For example, new intents may include updated phrases used by the user to request certain actions. Thus, the conversation service 162 may be used to store each user interaction with the virtual agent 150 to improve one or more of the plurality of tiers machine learning analysis.

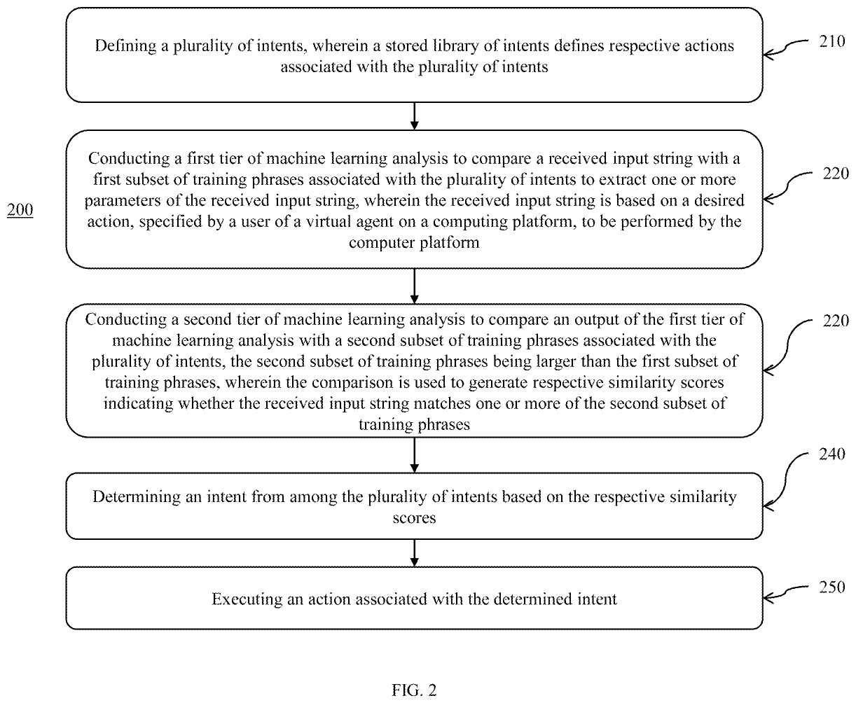

FIG. 2 is a flow chart of an example method 200 for executing, on a computing platform, an action based on a user command. In some embodiments, one or more processes described with respect to FIG. 2 may be performed by the server 120 of FIG. 1.

At 210, the method 200 may include defining a plurality of intents. In some embodiments, a stored library of intents defines respective actions associated with the plurality of intents.

At 220, the method 200 may include conducting a first tier of machine learning analysis to compare a received input string with a first subset of training phrases associated with the plurality of intents to extract the one or more parameters of the received input string. The received input string may be based on verbal command provided by a user to request a desired action to be performed by a computer platform. In some embodiments, the first tier of machine learning analysis may include an NER analysis.

At 230, the method 200 may include conducting a second tier of machine learning analysis to compare an output of the first tier of machine learning analysis with a second subset of training phrases associated with the plurality of intents. In some embodiments, the comparison may be used to generate similarity scores indicating whether the received input string matches one or more of the second subset of training phrases. In some embodiments, the second tier of machine learning analysis may include a natural language expression analysis, a fuzzy logic analysis, or an NLI analysis.

At 240, the method 200 may include determining an intent from among the plurality of intents based on the respective similarity scores.

At 250, the method 200 may include executing an action associated with the determined intent.

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system embodiments other than those described herein.

While this disclosure describes example embodiments for example fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

The foregoing description of the example embodiments will so fully reveal the general nature of the invention that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described example embodiments, but should be defined only in accordance with the following claims and their equivalents.

What is claimed is:

1. A method, comprising:
defining, by at least one processor, a plurality of intents, wherein a stored library of intents defines respective actions associated with the plurality of intents;
conducting, by the at least one processor, a first tier of machine learning analysis to compare a received input string with a first subset of training phrases associated with the plurality of intents to extract one or more parameters of the received input string, wherein the received input string is based on a desired action, specified by a user of a virtual agent on a computing platform, to be performed by the computer platform;
conducting, by the at least one processor, a second tier of machine learning analysis to compare an output of the first tier of machine learning analysis with a second subset of training phrases associated with the plurality of intents, wherein the comparison is used to generate respective similarity scores indicating whether the received input string matches one or more of the second subset of training phrases;
selecting, by the at least one processor, an intent from among the plurality of intents based on the respective similarity scores; and
executing, by the at least one processor, an action associated with the selected intent.

2. The method of claim 1, wherein the first tier of machine learning analysis comprises a named-entity recognition (NER) analysis.

3. The method of claim 1, wherein the second tier of machine learning analysis comprises a natural language expression analysis, a fuzzy logic analysis, a natural language inference analysis, or any combination thereof.

4. The method of claim 1, further comprising ranking previous actions requested by the user, and wherein the similarity scores are based on the ranking.

5. The method of claim 1, wherein conducting the second tier of machine learning analysis comprises:
replacing a portion of the received input string with the one or more parameters; and
comparing the received input string with the one or more parameters to the second subset of training phrases.

6. The method of claim 1, further comprising prompting the user to provide further information associated with the action.

7. The method of claim 1, further comprising storing the action performed as a new intent.

8. A system, comprising:
a memory; and
a processor coupled to the memory and configured to:
define a plurality of intents, wherein a stored library of intents defines respective actions associated with the plurality of intents;
conduct a first tier of machine learning analysis to compare a received input string with a first subset of training phrases associated with the plurality of intents to extract one or more parameters of the received input string, wherein the received input string is based on a desired action, specified by a user of a virtual agent on a computing platform, to be performed by the computer platform;
conduct a second tier of machine learning analysis, based on the output of the first tier of machine learning analysis, to compare an output of the first tier of machine learning analysis with a second subset of training phrases associated with the plurality of intents, wherein the comparison is used to generate respective similarity scores indicating whether the received input string matches one or more of the second subset of training phrases;
select an intent from among the plurality of intents based on the respective similarity scores; and
execute an action associated with the selected intent.

9. The system of claim 8, wherein the first tier of machine learning analysis comprises a named-entity recognition (NER) analysis.

10. The system of claim 8, wherein the second tier of machine learning analysis comprises a natural language expression analysis, a fuzzy logic analysis, a natural language inference analysis, or any combination thereof.

11. The system of claim 8, wherein the processor is further configured to rank previous actions requested by the user, and wherein the similarity scores are based on the ranking.

12. The system of claim 8, wherein, to conduct the second tier of machine learning analysis, the processor is further configured to:
replace a portion of the received input string with the one or more parameters; and
compare the received input string with the one or more parameters to the second subset of training phrases.

13. The system of claim 8, wherein the processor is further configured to prompt the user to provide further information associated with the action.

14. The system of claim 8, wherein the processor is further configured to store the action performed as a new intent.

15. A non-transitory computer-readable device having instructions stored thereon that, when executed by at least one computing device, cause the at least one computing device to perform operations comprising:
defining a plurality of intents, wherein a stored library of intents defines respective actions associated with the plurality of intents;
conducting a first tier of machine learning analysis to compare a received input string with a first subset of training phrases associated with the plurality of intents to extract one or more parameters of the received input string, wherein the received input string is based on a desired action, specified by a user of a virtual agent on a computing platform, to be performed by the computer platform;
conducting a second tier of machine learning analysis to compare an output of the first tier of machine learning analysis with a second subset of training phrases associated with the plurality of intents, wherein the comparison is used to generate respective similarity scores indicating whether the received input string matches one or more of the second subset of training phrases;
selecting an intent from among the plurality of intents based on the respective similarity scores; and
executing an action associated with the selected intent.

16. The non-transitory computer-readable device of claim 15, wherein the first tier of machine learning analysis comprises a named-entity recognition (NER) analysis.

17. The non-transitory computer-readable device of claim 15, wherein the second tier of machine learning analysis comprises a natural language expression analysis, a fuzzy logic analysis, a natural language inference analysis, or any combination thereof.

18. The non-transitory computer-readable device of claim 15, the operations further comprising ranking previous actions requested by the user, and wherein the similarity scores are based on the ranking.

19. The non-transitory computer-readable device of claim 15, wherein conducting the second tier of machine learning analysis comprises:
replacing a portion of the received input string with the one or more parameters; and
comparing the received input string with the one or more parameters to the second subset of training phrases.

20. The non-transitory computer-readable device of claim 15, the operations further comprising prompting the user to provide further information associated with the action.
